(19) United States
(12) Patent Application Publication
(10) Pub. No.: US 2004/0263658 A1
(43) Pub. Date: Dec. 30, 2004

(54) Display system and method having a customizable menu using levels of abstraction

(76) Inventors: Robert P. Cozier, Fort Collins, CO (US); Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/606,474

(22) Filed: Jun. 26, 2003

(51) Int. Cl. H04N 5/222

(52) U.S. Cl. 348/333.01; 348/333.02; 348/333.03; 348/333.12; 348/333.05

(57) ABSTRACT

A display system and method that implements a customizable menu using levels of abstraction. The display system and method may be advantageously employed in digital cameras, and the like. The present invention provides for the display and abstraction of a customizable menu that allows more or fewer actions to take place with a single initiated action.

### TECHNICAL FIELD

The present invention relates generally to display systems and methods, such as those involving digital cameras, and the like, and more specifically, to an improved display system and method that implements a customizable menu embodying levels of abstraction.

### BACKGROUND

The assignee of the present invention has heretofore developed a sharing system that is employed in digital cameras. This sharing system allows pictures to be transferred to external devices, specifically to allow printing of pictures and transfer of pictures to specific friends and family, for example. This sharing system requires a great number of button presses to perform actions on the part of the user.

For example, in the current sharing system, to allow for specific friends and family to be chosen, the user must have all of these individuals programmed in separately to a menu. Further, using the current sharing system, the user must go through and select each and every one of these individuals, which may equate to 15 button presses. It would be desirable to minimize the number of button presses that are required to implement desired actions.

It is an objective of the present invention to provide for an improved display system and method that implements a customizable menu embodying levels of abstraction. It is another objective of the present invention to provide for a digital camera embodying a display system and method that implements a customizable menu with levels of abstraction.

### SUMMARY OF THE INVENTION

To accomplish the above and other objectives, the present invention provides for an improved display system and method that implements a customizable menu having levels of abstraction. The present display system and method may be advantageously employed in digital cameras, and the like. The present invention provides for the display and abstraction of a customizable system that allows more or fewer actions to take place with a single initiated action.

The present invention minimizes the number of button presses it might take to perform actions on behalf of the user. The present invention improves upon the previously developed share system by enabling abstraction, which provide the user a choice, but also allows one button press to do the work that a large number of button presses would have using the previously developed share system.

The present invention allows the user to have a choice at the time of selection, not at the time of configuration. For example, rather than having an “all or nothing” approach to choosing a selection, the user could dive down into a menu to eliminate a specific individual from a list. Thus, the present invention may be used as a “deselecting” mechanism as well as a selection based mechanism. The options are then either choose everyone and unselect specifics from a subset, or select certain subsets and build up who the user wants to send information to. The present system and method allows for maximum customizability of destination while maintaining a similar complexity of design.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are front and back views, respectively, that illustrate an exemplary embodiment of a digital camera embodying a customizable share system, display system and display method in accordance with the principles of the present invention;

FIG. 2 illustrates an exemplary embodiment of the customizable share system, display system and display method in accordance with the principles of the present invention;

FIGS. 3-5 illustrate details of the exemplary customizable share system, display system and display method; and

FIG. 6 illustrates an exemplary method 60 in accordance with the present invention.

### DETAILED DESCRIPTION

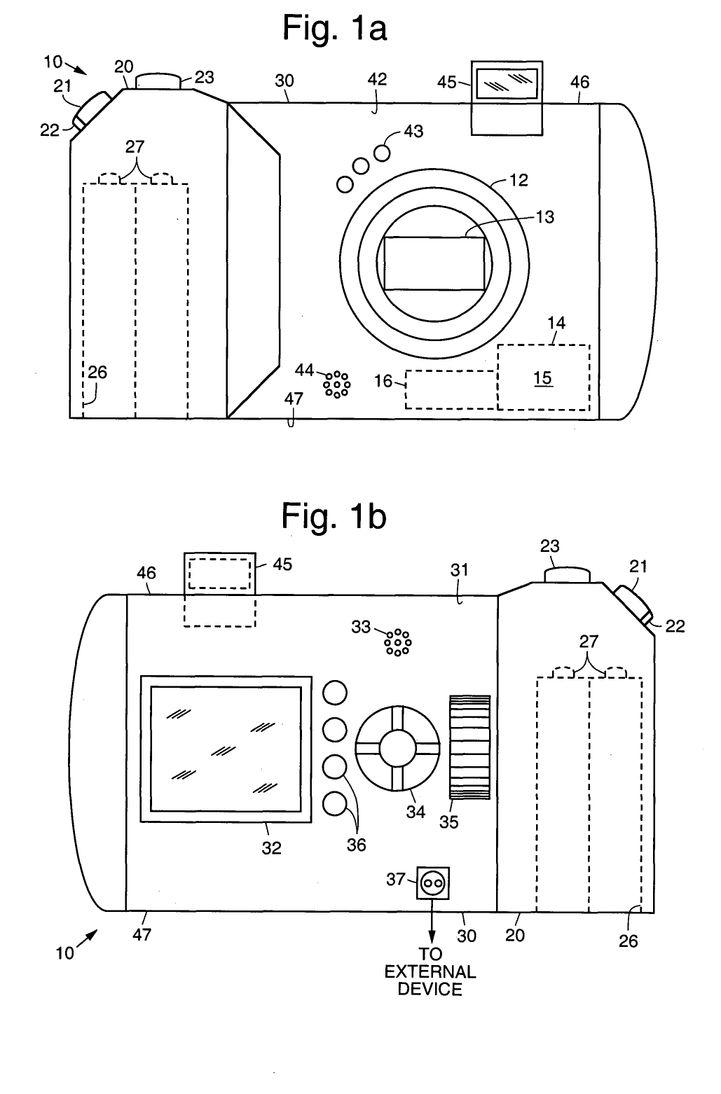

Referring to the drawing figures, FIGS. 1a and 1b show front and back views, respectively, that illustrate an exemplary embodiment of a system 10 in the form of a digital camera 10 that embodies a customizable share system 40, display system 50 and display method 60 in accordance with the principles of the present invention.

The exemplary digital camera 10 comprises a handgrip section 20 and a body section 30. The handgrip section 20 includes a power button 21 having a lock latch 22, a shutter button 23 (or record button 23), and a battery compartment 26 for housing batteries 27. A metering element 43 and microphone 44 are disposed on a front surface 42 of the digital camera 10. A pop-up flash 45 is located adjacent the top surface 46 of the digital camera 10.

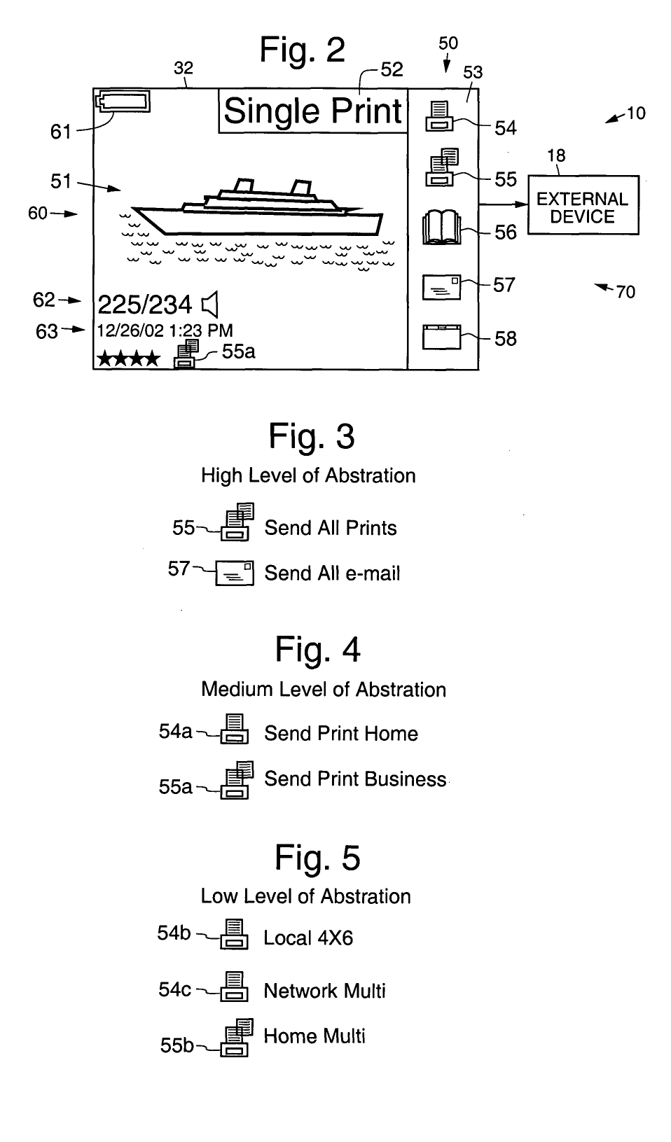

As is shown in FIG. 1b, a rear surface 31 of the exemplary digital camera 10 includes a display 32, such as a liquid crystal display (LCD) 32, for example, a rear microphone 33, a joystick pad 34, a zoom control dial 35, a plurality of buttons 36 for setting functions of the camera 10 and an output port 37 for downloading images 51 (FIG. 2) to an external device 18 (FIG. 2), such as a printer or computer, for example, or to another device 18 by way of the Internet, for example.

The digital camera 10 also comprises a lens 12, or imaging optics 12, and an image sensor 13 for receiving images 51 transmitted by the imaging optics 12. A processor 14 is coupled to the image sensor 13 (and other control and input/output components). The processor 14 is also coupled to image memory 16, which may include internal memory 16, nonvolatile memory 16 and removable memory 16. The processor 14 comprises an algorithm 15 which may be embodied in firmware 15, and that implements the present customizable share system 40, display system 50 and display method 60.

FIG. 2 illustrates an exemplary embodiment of the customizable share system 50, display system 60 and display method 70 in accordance with the principles of the present invention. FIGS. 3-5 illustrate details of the exemplary customizable share system 50, display system 60 and display method 70.

The exemplary customizable share system 50 shown in FIG. 2 includes a customizable menu 53. An exemplary customizable menu 53 may include a plurality of customizable and selectable icons 54, 55, 56, 57, 58, for example. Each of the icons 54-58 correspond to a selected task or action that may be performed with regard to a picture 51 or photographic image 51 that is taken by a user. However, it is to be understood that the icons 54-58 may be configured as “user interface items” 54-58, which may be icons or text, or combinations of icons or text. The user interface items 54-58 may be highlighted in the same manner as the icons 54-58 to implement the customizable menu 53. However, the balance of this description will use the term icon.

For example, a first icon 54 illustrates a printer icon 54 that is selected to print a single picture 51. A second icon 55 illustrates a printer icon 55 that is selected to print multiple or all pictures 51. A third icon 56 illustrates a book icon 56 that is selected to archive one or more pictures 51. A fourth icon 57 illustrates an envelope icon 57 that is selected to e-mail a picture 51. A fifth icon 58 illustrates a computer desktop icon 58 that is selected to download a picture 51 to a designated computer, for example.

The display 32 of the camera 10 is caused to display the selected picture 51 on which an action or actions are to be taken. The display 32 shows 61 a battery that indicates the amount of battery charge that is left. The display 32 shows 62 the number of the picture 51 (225/234). The display 32 also shows 63 the date (Dec. 26, 2002) and time (1:23. PM). In addition, the specific action that is being performed, illustrates as icon 55a, is also shown along with its progress, illustrated by a progression of stars, for example.

A key aspect of the present invention is to allow for the display and abstraction of the customizable share system 40 which allows more or fewer actions to take place with a single initiated action. As is shown in FIG. 2, in the exemplary customizable share system 50 for a digital camera 10, a user selects an image 51 or picture 51 in some manner then chose actions to be done to that picture 51, such as to make a single print 52 of a picture 51. This causes a through connection to be made to an (external) device 18, such as a printer, for example, and causes the selected picture 51 to be printed in a preprogrammed manner on the printer.

An exemplary menu 53 may be set up as follows (grouped for convenience):

Print operations—local 4×6, network A size photo printer multiple prints, multiple prints my printer at home.

E-mail operations—Business Team, Business Peer Team, Business manager.

Family Mom and Dad, Family Brother, Family Cousins, Family Grandma Cozier, Family Grandma Bellamy.

Friends Dave and Anne, Friends Lock Erin, Friends Will Allison, Friends Andy and Tom.

The construction of the menu 53 lends itself to categorization. In the language of xml, the items in the menu 53 may be considered elements in an entry of elements. Now the method 70 of abstraction implemented by the present invention comes from a need to vary based on a set or subset of persons to whom a specific item is sent. This comes with the realization that in the case of a camera system 10, an easy method 70 is desired to interact with the camera user interface, while at the same time allowing the user to select at will from a subset. An example of an implementation of the exemplary menu 53 previously discussed and shown in FIG. 2 is discussed below with reference to FIGS. 3-5. Although display method 70 and interaction may vary, this is an implementable version based on a sharing system developed by the assignee of the present invention.

FIG. 3 illustrates icons 55, 57 corresponding to a high level of abstraction. Selecting the illustrated icons 55, 57 allow all the underlying categorical actions to happen. These underlying categorical actions are shown in FIGS. 4 and 5.

FIG. 4 illustrates a medium level of abstraction which includes a printer icon 54a that sends a print home and a printer icon 55a that sends a print to a business office. FIG. 5 illustrates a low level of abstraction which includes a printer icon 54b that locally prints a 4 by 6 print, a printer icon 54c that prints multiple prints on a network printer, and a printer icon 55b that prints multiple prints on a home printer.

Similarly the e-mail operations corresponding to and activated by means of the envelope icon 57 might appear as follows:

Send All E-Mail→

Send E-mail-Family→Family Mom and Dad, Family Brother, Family Cousins, Family Grandma Cozier, Family Grandma Bellamy

Send E-mail Friends→Friends Dave and Anne, Friends Lock Erin, Friends Will Allison, Friends Andy and Tom

Send E-mail Work→Business Team, Business Peer Team, Business manager

Of course one may easily set up different levels of abstraction. For example, in “Send e-mail work”, one might set up a level of abstraction such that “send e-mail project” contains the Business Peer Team and the Business Manager. Of note is the instance at which some levels of abstraction are most basic, while others still allow grouping. If the Business grouping had several more layers of abstraction, for example, a solution would be to continually show the other layers in their most basic form while allowing a dive down into the grouped levels.

In order to make this example more concrete, consider imaging using a digital camera 10 with a menu 53 customized as outlined above. This may be done by customizing the menu 53 on a personal computer or other method. Initially bringing up the menu 53 might bring up the highest layer of abstraction. Let's say the user is on vacation in Hawaii and would like to make everyone jealous. By “checking” and/or selecting the envelope icon 57 corresponding to “Send all e-mail”, the selected picture would be sent to any and all e-mail addresses currently configured (or perhaps configured in the future).

Assuming that the user is cognizant of the fact that it may not be appropriate to send everyone an e-mail about this picture, the user could select a lower abstraction layer (such as by depressing a right arrow button of the plurality of buttons 36 or a designated selection using the joystick pad 34, for example) and chose to e-mail friends and family, for example, in accordance with the exemplary grouping illustrated above. Further if the user wanted to select specific friends and family members, moving down one more layer would bring up specific friends or specific family that may be selected. Again, the specifically configured menu 53 and share system 50 may enable further abstraction such as e-mail business, or e-mail selected persons which might group both friends and family.

The present invention minimizes the number of button presses it might take to perform actions on behalf of the user. The present invention improves upon the previously developed share system by enabling abstraction, which provides the user a choice, but also allows one button press to do the work that a large number of button presses (15, for example) would have using the previously developed share system.

As mentioned above, this also allows the user to have a choice at selection, not at configuration. For example rather than having an “all or nothing” approach to choosing a selection one could dive down into a menu to eliminate a specific individual from the list. For example, the user might chose to e-mail everyone, dive down one layer, and unselect e-mail work. Thus, the present menu 53 and share system 50 can be a “deselecting” mechanism as well as a selection-based mechanism. The options are then either chose everyone and unselect specifics from a subset, or select certain subsets and build up who you want to send data to. The menu 53, share system 50 and share method 70 then allows for maximum customizability of destination while maintaining a similar complexity of design.

In order to configure the menu 53, and by way of example, a user interface may be provided on a computer that is coupled to the camera 10 that allows selection of layers. Once the layer configuration is set up, this information is transferred by way of a file download, for example, from the computer to the camera 10 or device 10. Other transfer mechanisms may readily be employed. The transferred information is stored in a nonvolatile memory 16 of the camera 10 or device 10. The information stored in the nonvolatile memory 16 is retrieved during power up of the camera 10 or device 10 and formatted appropriately to generate the menu 53.

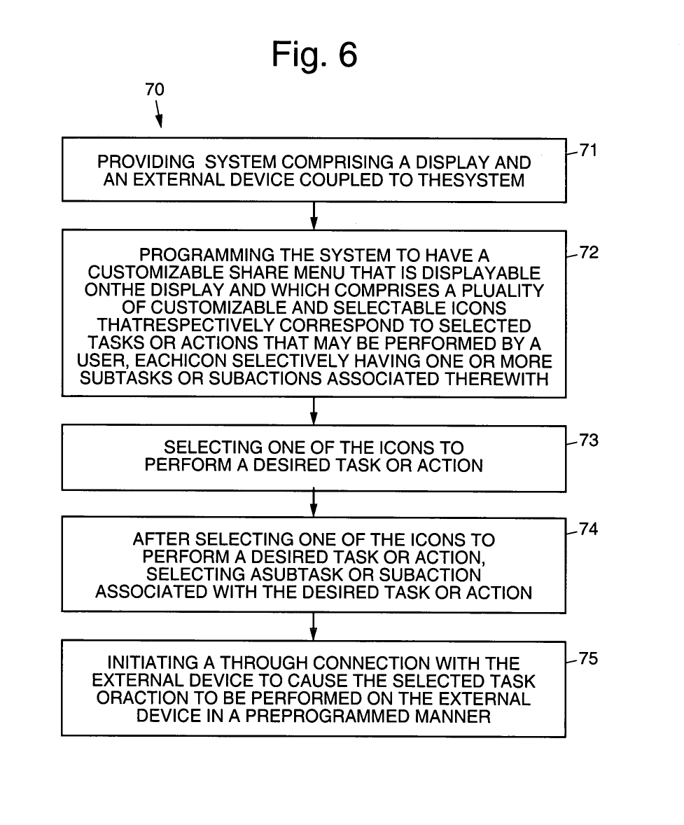

For the purposes of completeness, FIG. 6 illustrates an exemplary method 60 in accordance with the present invention. The exemplary method 70 comprises the following steps.

A system 10 is provided 71 that comprises a display 32 and an external device 18 coupled to the system 10. The system 10 is programmed 72 to have a customizable menu 53 that is displayable on the display 32 and which comprises a plurality of customizable and selectable icons 54-58 that respectively correspond to selected tasks or actions that may be performed by a user, each icon selectively having one or more subtasks or sub-actions associated therewith.

One of the icons 54-58 is activated 73 or selected 73 to perform a desired task or action. After selecting 73 one of the icons 54-58 to perform a desired task or action, a subtask or sub-action associated with the desired task or action may be selected 74. A through connection with the external device 18 is initiated 75 to cause the selected task or action to be performed on the external device 18 in a preprogrammed manner.

It should be clear from the above that the present invention provides for many benefits based upon the ability to provide abstraction relating to tasks that may be performed that make it relatively easy for a user to perform the tasks. In particular, the present invention permits a single user action (i.e., “one icon selection” or “one button press”) to implement a desired task that previously took a great number of button presses by the user to perform.

Thus, an improved display system and method embodying a customizable share system using levels of abstraction have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A system comprising:
a display;
an external device coupled to the system; and
customizable menu that is displayable on the display and which comprises a plurality of customizable and selectable user interface items that respectively correspond to selected tasks or actions that may be performed by a user, each user interface item having one or more subtasks or sub-actions associated therewith, which tasks/actions and subtasks/sub-actions are selectable by the user and which initiates a through connection with the external device, and causes the selected task or action to be performed on the external device in a preprogrammed manner.

2. The system recited in claim 1 which comprises a digital camera.

3. The system recited in claim 1 wherein the tasks are selected from the group consisting of printing, e-mailing, archiving and downloading data from the system.

4. The system recited in claim 1 wherein the external device comprises a printer.

5. The system recited in claim 1 wherein the external device comprises a computer.

6. A method comprising the steps of;
providing a system comprising a display and an external device coupled to the system;
programming the system to have a customizable menu that is displayable on the display and which comprises a plurality of customizable and selectable user interface items that respectively correspond to selected tasks or actions that may be performed by a user, each icon selectively having one or more subtasks or sub-actions associated therewith;
selecting one of the icons to perform a desired task or action; and
initiating a through connection with the external device to cause the selected task or action to be performed on the external device in a preprogrammed manner.

7. The method recited in claim 6 further comprising the step of:
after selecting one of the icons to perform a desired task or action, selecting a subtask or sub-action associated with the desired task or action.

8. The method recited in claim 6 wherein the system comprises a digital camera.

9. The method recited in claim 6 wherein the tasks are selected from the group consisting of printing, e-mailing, archiving and downloading data from the system.

10. The method recited in claim 6 wherein the external device comprises a printer.

11. The method recited in claim 6 wherein the external device comprises a computer.
